(19) United States
(12) Patent Application Publication
(10) Pub. No.: US 2022/0325855 A1
(43) Pub. Date: Oct. 13, 2022

(54) WAVELENGTH CONVERSION DEVICE

(71) Applicant: SONY GROUP CORPORATION, TOKYO (JP)

(72) Inventors: HIROKI MORITA, TOKYO (JP); YUKI MAEDA, TOKYO (JP); IZUSHI KOBAYASHI, TOKYO (JP)

(21) Appl. No.: 17/754,205

(22) PCT Filed: Sep. 14, 2020
(86) PCT No.: PCT/JP2020/034650

§ 371 Date: Mar. 25, 2022

(30) Foreign Application Priority Data
Oct. 2, 2019 (JP) 2019-182226

(51) Int. Cl. F21K 9/64; G03B 21/16; G03B 21/20

(52) U.S. Cl. CPC F21K 9/64; G03B 21/16; G03B 21/204; G03B 21/2066

(57) ABSTRACT

A wavelength conversion device according to one embodiment of the present disclosure includes: a phosphor layer including a plurality of phosphor particles; a refrigerant that cools the phosphor layer; a circulation path that contains the phosphor layer and the refrigerant, and in which the refrigerant circulates; and a waveguide separated from the circulation path, and through which excitation light that excites the phosphor layer and a fluorescence excited by the excitation light and outputted from the phosphor layer propagate.

### TECHNICAL FIELD

The present disclosure relates to a wavelength conversion device that uses phosphor particles.

### BACKGROUND ART

In recent years, a light source of a projector has gradually been replaced from a lamp light source to a laser excitation phosphor light source. A fluorescence conversion efficiency of the laser excitation phosphor light source decreases with an excitation light density and a temperature increase of a phosphor. For example, Patent Literature 1 discloses an illumination apparatus configured by an excitation light source, a light tunnel having a hollow square tube shape and in which an inner side hollow part serves as a light guiding path, and a phosphor layer provided on an inner face of the light tunnel. For example, Patent Literature 2 discloses a wavelength conversion member in which a plurality of particles containing a refrigerant and phosphor particles is sealed in a sealed housing.

### CITATION LIST

### Patent Literature

Patent Literature 1: Japanese Unexamined Patent Application Publication No. 2016-157096

Patent Literature 2: Japanese Unexamined Patent Application Publication No. 2016-225148

### SUMMARY OF THE INVENTION

Incidentally, an improvement of a light extraction efficiency has been desired for a laser excitation phosphor light source.

It is desirable to provide a wavelength conversion device that makes it possible to improve a light extraction efficiency.

A wavelength conversion device according to one embodiment of the present disclosure includes: a phosphor layer including a plurality of phosphor particles; a refrigerant that cools the phosphor layer; a circulation path that contains the phosphor layer and the refrigerant, and in which the refrigerant circulates; and a waveguide separated from the circulation path, and through which excitation light that excites the phosphor layer and a fluorescence excited by the excitation light and outputted from the phosphor layer propagate.

The wavelength conversion device according to one embodiment of the present disclosure prevents scattering of the excitation light and the fluorescence caused by the refrigerant, by separating the circulation path in which the refrigerant circulates and the waveguide through which the excitation light and the fluorescence propagate.

### BRIEF DESCRIPTION OF THE DRAWINGS

FIG. 1 is a schematic diagram illustrating an example of a schematic configuration of a wavelength conversion device according to an embodiment of the present disclosure.

FIG. 2 is a cross-sectional schematic diagram illustrating an example of a configuration of the wavelength conversion device illustrated in FIG. 1.

FIG. 3 is a flowchart illustrating a manufacturing process of a phosphor layer.

FIG. 4 is a characteristic diagram illustrating a change in phosphor temperature with respect to an excitation light amount.

FIG. 5 is a cross-sectional schematic diagram illustrating an example of a schematic configuration of a wavelength conversion device according to modification example 1 of the present disclosure.

FIG. 6 is a cross-sectional schematic diagram illustrating an example of a schematic configuration of a wavelength conversion device according to modification example 2 of the present disclosure.

FIG. 7 is a cross-sectional schematic diagram illustrating an example of a schematic configuration of a wavelength conversion device according to modification example 3 of the present disclosure.

FIG. 8 is a cross-sectional schematic diagram illustrating another example of the schematic configuration of the wavelength conversion device according to the modification example 3 of the present disclosure.

FIG. 9 is a cross-sectional schematic diagram illustrating an example of a schematic configuration of a wavelength conversion device according to modification example 4 of the present disclosure.

FIG. 10 is a schematic diagram illustrating an example of a schematic configuration of a wavelength conversion device according to modification example 5 of the present disclosure.

FIG. 11 is a schematic diagram illustrating an example of a schematic configuration of a wavelength conversion device according to modification example 6 of the present disclosure.

FIG. 12 is an outline diagram illustrating an example of a configuration of a light source module having the wavelength conversion device illustrated in FIG. 1 or the like.

FIG. 13 is an outline diagram illustrating an example of a configuration of a projector that includes the light source module illustrated in FIG. 12.

FIG. 14 is an outline diagram illustrating another example of the configuration of the projector that includes the light source module illustrated in FIG. 12.

FIG. 15 is a flowchart describing an example of a light-emission wavelength variation feedback function in the projector illustrated in FIG. 13 or the like.

FIG. 16 is a flowchart describing another example of the light-emission wavelength variation feedback function in the projector illustrated in FIG. 13 or the like.

FIG. 17 is a schematic diagram illustrating an optical chopper in FIG. 16.

### MODES FOR CARRYING OUT THE INVENTION

The following describes embodiments of the present disclosure in detail with reference to the drawings. The following description is a specific example of the present disclosure, but the present disclosure is not limited to the following embodiment. In addition, the present disclosure is not limited to arrangement, dimensions, dimensional ratios, and the like of the constituent elements illustrated in the drawings. It is to be noted that the description is given in the following order.

### 1. Embodiment

(an example of a wavelength conversion device in which a cylindrical columnar structure member having a double structure serves as a container section, and in which a hollow part serves as a waveguide of excitation light and fluorescence and a cylindrical inner space serves as a circulation path of a refrigerant)

1-1. Configuration of Wavelength Conversion Device

1-2. Cooling System of Wavelength Conversion Device

1-3. Workings and Effects

### 2. Modification Examples

2-1. Modification Example 1 (an example in which a columnar structure member having a multangular shape is used as the container section)

2-2. Modification Example 2 (an example in which a visible light reflection section is provided between a phosphor layer and an inner side outer circumferential face of the columnar structure member)

2-3. Modification Example 3 (an example in which phosphor particles and transparent particles are mixed to form the phosphor layer)

2-4. Modification Example 4 (an example in which an opening is provided on the phosphor layer)

2-5. Modification Example 5 (an example in which multiple kinds of phosphor particles are used to form the phosphor layer)

2-6. Modification Example 6 (an example of a reflective wavelength conversion device)

3. Application Examples (examples of a light source module and a projector)

### 4. Applied Examples

### 1. EMBODIMENT

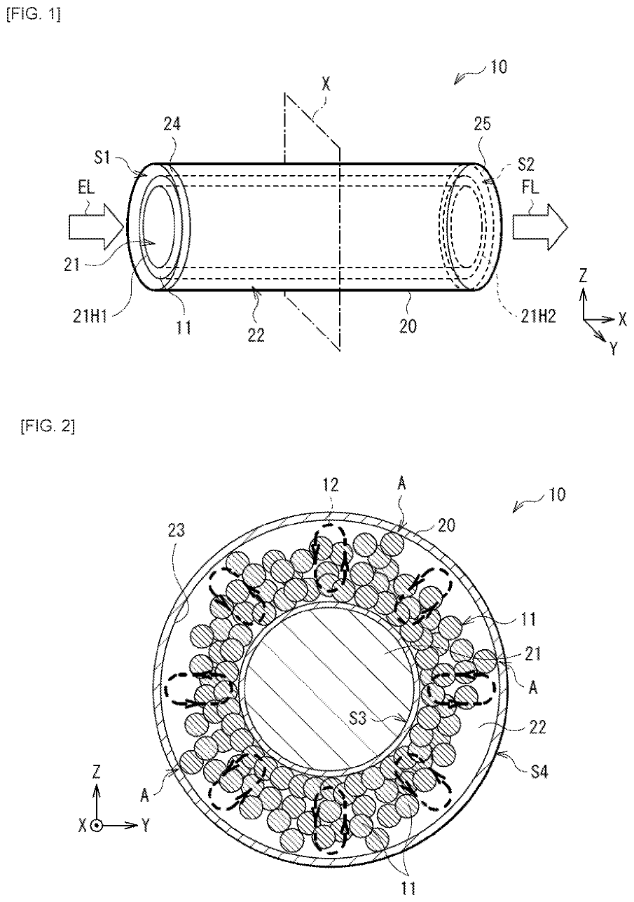

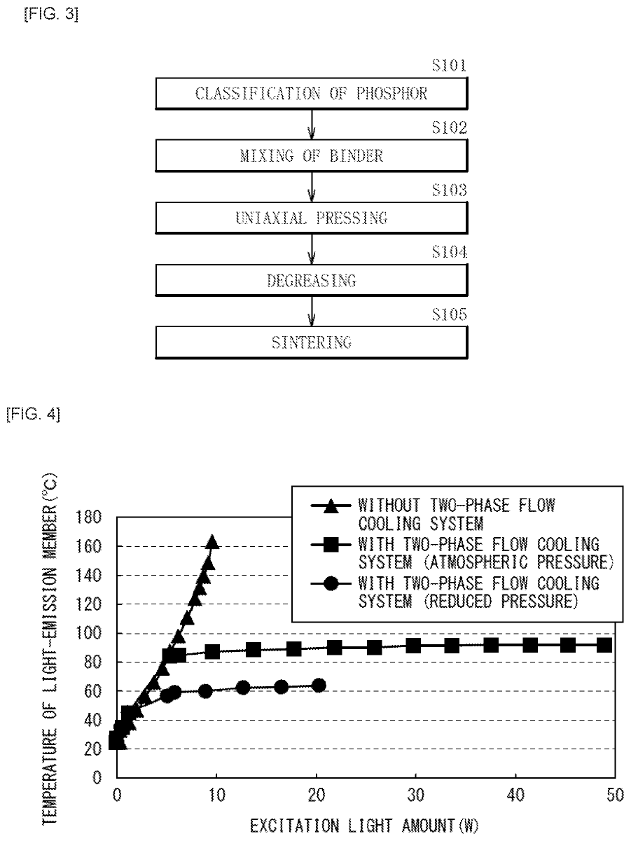

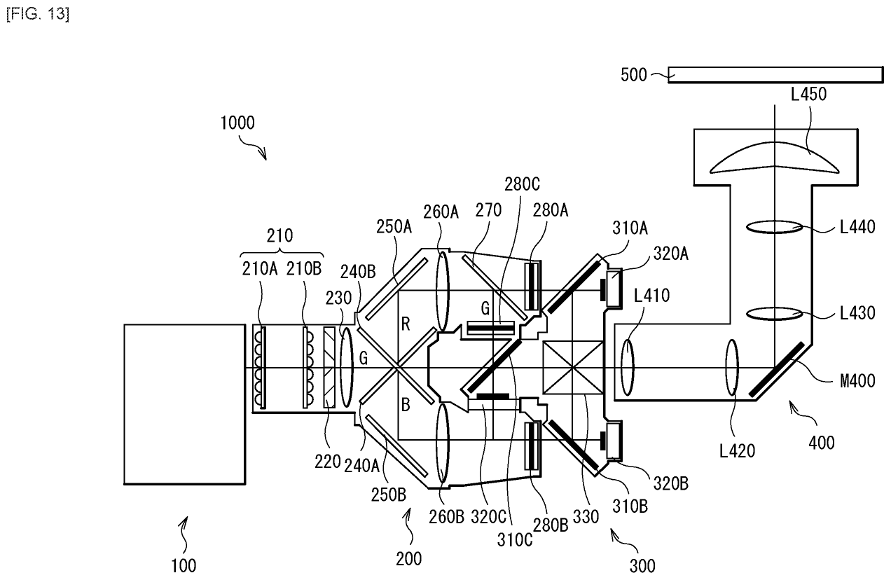

FIG. 1 schematically illustrates an example of a schematic configuration of a wavelength conversion device (a wavelength conversion device 10) according to an embodiment of the present disclosure. FIG. 2 schematically illustrates an example of a cross-sectional configuration of the wavelength conversion device 10 in an X plane illustrated in FIG. 1. The wavelength conversion device 10 constitutes, for example, a light source module (a light source module 100) of a projection type display apparatus (for example, a projector 1000) described later (see FIGS. 12 and 13). The wavelength conversion device 10 according to the present embodiment has a configuration in which a waveguide 21 through which excitation light EL that excites a phosphor layer 11 and fluorescence FL emitted from the phosphor layer 11 by being excited by the excitation light EL propagate and a circulation path 22 in which a refrigerant 12 that cools the heated phosphor layer 11 circulates are formed separately.

### 1-1. Configuration of Wavelength Conversion Device

The wavelength conversion device 10 has a so-called two-phase cooling structure, in which the phosphor layer 11 is cooled directly by a vaporization latent heat of the refrigerant 12. In the present embodiment, a cylindrical columnar structure member having a double structure is used as a container section 20 that contains the phosphor layer 11 and the refrigerant 12. The columnar structure member, i.e., the container section 20 has an opposing pair of end faces (faces S1 and S2) and an inner circumferential face S3 and an outer circumferential face S4 that form side faces. The phosphor layer 11 and the refrigerant 12 are hermetically sealed in an inner space of the columnar structure member, which is formed by the faces S1 and S2, the inner circumferential face S3, and the outer circumferential face S4. The columnar structure member further has a hollow structure section on an inner side of the inner circumferential face S3, and the hollow structure section is open by opening sections 21H1 and 21H2 provided respectively on the faces S1 and S2. In the wavelength conversion device 10 according to the present embodiment, the hollow structure section is used as the waveguide 21 of the excitation light EL and the fluorescence FL, and the inner space described above is used as the circulation path 22 of the refrigerant 12. A face, of the outer circumferential face S4, that faces the circulation path 22 serves as a visible light reflection section 23. Further, a fluorescence reflection section 24 is provided at the opening section 21H1 of the waveguide 21 into which the excitation light EL enters, and a divergence angle control section 25 is provided at the opening section 21H2 from which the fluorescence FL is outputted. Hereinafter, respective constituent members that constitute the wavelength conversion device 10 will be described.

The phosphor layer 11 includes a plurality of phosphor particles 111, and is formed, for example, along the inner circumferential face S3 that constitutes the circulation path 22. The phosphor layer 11 is preferably formed as, for example, a continuous foam type porous layer, and is configured by, for example, a so-called ceramic phosphor or a binder type porous phosphor.

The phosphor particle 111 is a particulate phosphor that absorbs the excitation light EL outputted from a later-described light source section 110 and emits the fluorescence FL. As the phosphor particle 111, a fluorescent substance is used in which the excitation light EL is absorbed by, for example, 50% or greater and emits the fluorescence containing a wavelength smaller than a wavelength of the excitation light EL, for example, a wavelength of 480 nm or greater and 680 nm or less, or a wavelength of 600 nm or greater and 680 nm or less. Specifically, for example, a fluorescent substance is used that is excited by blue laser light having a wavelength of a blue wavelength band (e.g., 400 nm or greater and 470 nm or less) and emits yellow fluorescence (light of a wavelength band between a red wavelength band and a green wavelength band). Examples of the fluorescent substance include YAG (yttrium aluminum garnet) based material and LAG (lutetium aluminum garnet) based material. An average particle size of the phosphor particle 111 is, for example, 5 nm or greater and 30 μm or less.

As the phosphor particle 111, further, it is possible to use a quantum dot. In a case where the quantum dot is used, it is desirable that the quantum dot be encapsulated by or coated with an inorganic material such as silicon oxide (SiO₂), titanium oxide (TiO₂), or aluminum oxide (Al₂O₃). This reduces degradation due to the refrigerant 12 (e.g., water).

It should be noted that an absorption rate of the excitation light EL depends on an absorption coefficient a inside the phosphor layer 11 and a length x of the phosphor layer 11, and I=I₀exp(−αx) is defined where an intensity of the excitation light EL after the absorption is I and an intensity of the excitation light EL before the absorption is I₀, and the absorption rate is derived as I/I₀. A numerical value of α is defined by a phosphor concentration. In a case where I/I₀≤0.5 is satisfied, the length x of the phosphor layer 11 is defined as x≤−log 0.5/α. It should be noted that, here, the length x of the phosphor layer 11 is a length in an X-axis direction.

It is preferable that at least a portion of the phosphor layer 11 be in contact with the outer circumferential face S4 that constitutes the circulation path 22 as illustrated in FIG. 2. This makes it easier for the refrigerant 12 to circulate efficiently between inside and outside of the phosphor layer 11 in a cooling cycle of the wavelength conversion device 10 described later.

It is possible to form the phosphor layer 11 as follows, for example. First, a particle size of the phosphor particle 111 is controlled by a phosphor classification (step S101). Subsequently, the phosphor particle 111 and a binder are mixed (step S102). Next, uniaxial pressing is performed by controlling a press pressure (step S103). Subsequently, degreasing is performed (step S104), following which sintering is performed (step S105). Thus, the phosphor layer 11 configured by a sintered phosphor is formed. It is possible to adjust an average pore diameter of the sintered phosphor to a desired value by controlling the phosphor classification in step S101, the press pressure in the uniaxial pressing in step S103, and a sintering temperature in step S105.

The refrigerant 12 circulates the inside and the outside of the phosphor layer 11 disposed in the circulation path 22 as indicated by an arrow illustrated in FIG. 2, for example, to cool a heat-generation part of the phosphor layer 11 heated by application of the excitation light EL. As for the refrigerant 12, for example, a liquid having a large latent heat is preferably used, and for example, a vaporization heat is preferably 10 cal/g or greater. Further, because the refrigerant 12 circulates through a void formed in the phosphor layer 11 and a portion at which the phosphor layer 11 and the outer circumferential face S4 are in contact with each other (a contact section A, see FIG. 2), it is preferable that a viscosity be low. Examples of the specific refrigerant 12 include water, acetone, methanol, naphthalene, and benzene.

The container section 20 is the cylindrical columnar structure member having the double structure, and has the sealed inner space configured by the opposing pair of end faces (the faces S1 and S2) and the inner circumferential face S3 and the outer circumferential face S4 that form the side faces, and the hollow structure section on the inner side of the inner circumferential face S3. In the present embodiment, the hollow structure section is used as the waveguide 21, and the inner space is used as the circulation path 22. Out of the pair of end faces that serve as end parts of the columnar structure member, the face S1 has the opening section 21H1 that opens the hollow structure section and serves as an entrance opening section of the excitation light EL, and the face S2 has the opening section 21H2 that opens the hollow structure section and serves as an output opening section of the fluorescence FL.

The container section 20 is configured by, for example, the following materials. The inner circumferential face S3 includes, for example, a material having a light-transmitting property. Specifically, besides a glass substrate, it is possible to use, for example, soda glass, quartz, sapphire glass, quartz, and the like. In addition, in a case where an output of laser light (the excitation light EL) to be outputted from the light source section 110 is low, it is possible to use a resin or the like such as polyethylene terephthalate (PET), a silicone resin, a polycarbonate, or acrylic. For example, as with the inner circumferential face S3, the outer circumferential face S4 may be formed by using a material having a light-transmitting property; for example, it is preferable that aluminum, copper, stainless steel, low-carbon steel, or an alloy material thereof, or high thermal conductivity ceramics such as silicon carbide or aluminum nitride be used. This allows a vapor of the refrigerant 12 vaporized by the phosphor layer 11 to phase change into a liquid, making it possible to circulate the refrigerant 12 efficiently between the inside and the outside of the phosphor layer 11. For example, the face S1 and the face S2 may be formed using a material having a light-transmitting property as with the inner circumferential face S3, but are preferably formed using the same material as the later-described visible light reflection section 23 in order to prevent the fluorescence FL and the excitation light EL from being outputted to the outside.

The waveguide 21 is for causing the excitation light EL outputted from the light source section 110 and the fluorescence FL emitted from the phosphor layer 11 to propagate from the opening section 21H1 to the opening section 21H2. The waveguide 21 is formed by the inner circumferential face S3 of the container section 20, and the inner side of the inner circumferential face S3 is filled with, for example, air or a transparent material having a refractive index of 1 or greater.

The circulation path 22 is a region in which the refrigerant 12 is phase-changed and circulated between the inside and the outside of the phosphor layer 11, and is formed in the inner space configured by the faces S1 and S2, the inner circumferential face S3, and the outer circumferential face S4 of the container section 20.

A face, of the outer circumferential face S4, that faces the circulation path 22 is preferably further configured as the visible light reflection section 23 that reflects visible light. The phosphor particle 111 excited by the excitation light EL emits light isotropically. Accordingly, a portion of the fluorescence FL emitted in the phosphor layer 11 may sometimes be emitted from the inside of the phosphor layer 11 to the circulation path 22 side. Hence, by making the outer circumferential face S4 the visible light reflection section 23, the fluorescence FL emitted into the circulation path 22 is reflected by the visible light reflection section 23 and enters the phosphor layer 11. This increases a proportion of the fluorescence FL to be taken out to the waveguide 21. That is, it is possible to improve a light extraction efficiency. In addition, for example, a portion of the excitation light EL that is applied to the phosphor layer 11 and propagates inside the phosphor layer 11 while being subjected to multi-excitation may sometimes be transmitted from the inside of the phosphor layer 11 to the circulation path 22 side. It is also possible to cause the excitation light EL having transmitted to the circulation path 22 to enter the phosphor layer 11 again. That is, it is possible to improve a use efficiency of the excitation light EL. It is possible to form the visible light reflection section 23, for example, by forming a dielectric multilayered film on the face, of the outer circumferential face S4, that faces the circulation path 22. In addition, in a case where the outer circumferential face S4 is formed using a material having a light-reflective property such as aluminum, it is possible to use the outer circumferential face S4 as the visible light reflection section 23. The visible light reflection section 23 corresponds to one concrete example of a “second reflection section” of the present disclosure.

For the opening section 21H1, for example, it is preferable to form the fluorescence reflection section 24 that causes the excitation light EL to transmit therethrough and reflects the fluorescence FL. A portion of the fluorescence FL emitted in the phosphor layer 11 propagates the waveguide 21 in a direction of the opening section 21H1. By providing the fluorescence reflection section 24 at the opening section 21H1, the fluorescence FL having propagated through the waveguide 21 to the opening section 21H1 is reflected by the fluorescence reflection section 24 and propagates the waveguide 21 in a direction of the opening section 21H2. Thus, a proportion of the fluorescence FL to be outputted from the opening section 21H2 increases. That is, it is possible to improve a light extraction efficiency. It is possible to form the fluorescence reflection section 24, for example, by forming a dielectric multilayered film on a substrate having a light-transmitting property. The fluorescence reflection section 24 corresponds to one concrete example of a “first reflection section” of the present disclosure.

For the opening section 21H2, for example, it is preferable to form the divergence angle control section 25 that controls a divergence angle of, for example, the fluorescence FL to be outputted from the opening section 21H2, for example. The opening section 21H2 outputs the fluorescence FL and a portion of the excitation light EL that has not been absorbed by the phosphor layer 11. The smaller the divergence angle of the light outputted from the opening section 21H2, the higher the projection luminance of a projector 1000 described later. Accordingly, by providing the divergence angle control section 25 at the opening section 21H2, it is possible to improve a directivity of the light to be outputted from the opening section 21H2. It is possible to form the divergence angle control section 25 using, for example, a dielectric material which is highly transparent to the visible light. Examples of the dielectric material include glass, quartz, a silica-based material, titanium oxide, and sapphire.

It should be noted that, in FIG. 1, an example is illustrated in which the fluorescence reflection section 24 and the divergence angle control section 25 each have the same shape as the end faces (the faces S1 and S2) of the columnar structure member that constitutes the container section 20, but they are not limited thereto. For example, the fluorescence reflection section 24 and the divergence angle control section 25 may have shapes that cover only the opening sections 21H1 and 21H2.

A side face of the container section 20, for example, a face, of the outer circumferential face S4, that faces the outside may be further provided with a heat dissipation member (not illustrated) that cools the container section 20. Thus, a heat dissipation efficiency of the container section 20 is improved, and the phase change of the refrigerant 12 in the circulation path 22 from the vapor to the liquid is promoted. Accordingly, it is possible to improve a cooling efficiency. It is possible to form the heat dissipation member, for example, by a plurality of radiator fins. Alternatively, a Peltier device or a water cooling system such as a water cooling plate may be used as the heat dissipation member.

### 1-2. Cooling System of Wavelength Conversion Device

The cooling cycle of the wavelength conversion device 10 according to the present embodiment will be described.

As described above, the wavelength conversion device 10 according to the present embodiment has the two-phase cooling structure in which the sealed inner space of the container section 20 serves as the circulation path 22 and the refrigerant 12 is sealed together with the phosphor layer 11 inside the circulation path 22, and the phosphor layer 11 is directly cooled by the vaporization latent heat of the refrigerant 12.

In the wavelength conversion device 10, the refrigerant 12 sealed inside the circulation path 22 is held by a capillary force between particles of the plurality of phosphor particles 111 configuring the phosphor layer 11. In the wavelength conversion device 10, first, when the phosphor layer 11 is irradiated with the excitation light EL, the phosphor particle 111 absorbs the excitation light EL and generates a heat. The refrigerant 12 is vaporized by the heat and at the same time deprives a latent heat. The refrigerant 12 is vaporized by the heat and at the same time deprives a latent heat. The vaporized refrigerant 12 moves to an outer part of the phosphor layer 11 as a vapor as illustrated in FIG. 2. The vapor of the refrigerant 12 which has moved to the outer part of the phosphor layer 11 releases the latent heat through the outer circumferential face S4 of the container section 20 and is cooled and liquefied again. When the liquefied refrigerant 12 comes into contact with the phosphor layer 11, it penetrates between the particles of the plurality of phosphor particles 111 by the capillary force of the phosphor layer 11. By repeating this, the heat-generation part of the phosphor layer 11 which is heated by the application of the excitation light EL is cooled.

The capillary force is represented by the following expression. As can be seen from the expression (1), the capillary force of the phosphor layer 11 becomes larger as a contact angle is smaller. Accordingly, it is desirable that a material configuring the phosphor layer 11 have wettability.

(Expression 1) P=2T cos θ/μgr (1)

(P: the capillary force, T: a surface tension, θ: the contact angle, ρ: a liquid density, g: a gravitational acceleration, r: a capillary radius)

### 1-3. Workings and Effects

In the wavelength conversion device 10 according to the present embodiment, the circulation path 22 in which the phosphor layer 11 and the refrigerant 12 are contained and in which the refrigerant 12 circulates between the inside and the outside of the phosphor layer 11 and the waveguide 21 through which the excitation light EL and the fluorescence FL emitted from the phosphor layer 11 by the application of the excitation light EL propagate are formed separately. Thus, it is possible to prevent scattering of the excitation light EL and the fluorescence FL by the refrigerant 12. This will be described below.

As described above, a light source of a projector has gradually been replaced from a lamp light source to a laser excitation phosphor light source. For the laser excitation phosphor light source, a mainstream is a method of extracting a fluorescent light emission by irradiating a phosphor with blue laser light having a high energy as excitation light. A proportion of power of the fluorescent light emission to power of the excitation light incident on the phosphor is called a fluorescence conversion efficiency. The fluorescent light emission efficiency decreases with a density of the excitation light and a temperature increase of the phosphor.

For example, an illumination apparatus has been developed in which a hollow part on an inner side of a reflection member having a hollow rectangular cylindrical shape serves as a light guiding path and a phosphor layer is provided on an inner face thereof. In this illumination apparatus, an extraction efficiency of a fluorescence is improved by applying excitation light from one opening section of the reflection member and extracting the fluorescence from the other opening section. In this illumination apparatus, by providing a heat sink on an outer side of the reflection member as a cooling mechanism, a heat generated in the phosphor layer is radiated through the reflection member to suppress the temperature increase of the phosphor. However, in such a cooling mechanism, the phosphor layer is cooled through the inner face of the reflection member. Accordingly, a thermal resistivity is large and it is difficult to obtain a sufficient cooling performance.

In addition, for example, a light source apparatus has been developed in which a refrigerant, a wavelength conversion member containing phosphor particles, and a flow section having a plurality of fine flow channels configured to flow the refrigerant are sealed in a sealed housing that partially includes a translucent surface. This light source apparatus makes it possible to directly cool a phosphor by a circulation of the refrigerant. However, in such a light source apparatus, a circulation path of the refrigerant overlaps a propagation path of excitation light and a fluorescence. Accordingly, the excitation light and the fluorescence are scattered by the refrigerant, and a light extraction efficiency can decrease.

In contrast, in the wavelength conversion device 10 according to the present embodiment, the phosphor layer 11 and the refrigerant 12 are contained in the sealed inner space formed by, for example, the opposing pair of end faces (the faces S1 and S2) and the inner circumferential face S3 and the outer circumferential face S4 that form the side faces of the cylindrical columnar structure member having the double structure to form the circulation path 22 of the refrigerant 12. In addition, the hollow structure section formed on the inner side of the inner circumferential face S3 of the cylindrical columnar structure member having the double structure serves as the waveguide 21 of the excitation light EL and the fluorescence FL. In other words, in the present embodiment, the waveguide 21 and the circulation path 22 are separated from each other. Thus, the phosphor having been subjected to a heat generation by the excitation light EL is directly cooled by the refrigerant 12. Hence, the decrease in the fluorescent light emission efficiency by the temperature increase of the phosphor is suppressed. Further, the waveguide 21 through which the excitation light EL and the fluorescence FL propagate and the circulation path 22 of the refrigerant 12 are independent, making it possible to prevent the scattering of the excitation light EL and the fluorescence FL by the refrigerant 12 described above.

As described above, according to the present embodiment, the waveguide 21 through which the excitation light EL and the fluorescence FL propagate and the circulation path 22 in which the refrigerant 12 that directly cools the phosphor layer 11 by the vaporization latent heat circulates are formed separately. Thus, it is possible to extract the fluorescence FL emitted from the phosphor layer 11 and the excitation light EL not absorbed by the phosphor layer 11 without involving the scattering by the refrigerant 12. Hence, it is possible to improve the light extraction efficiency.

In addition, in the wavelength conversion device 10 according to the present embodiment, the two-phase cooling technique is used, making it possible to keep a temperature of the phosphor layer 11 constant. For example, FIG. 4 illustrates a temperature change of a phosphor relative to an excitation light amount in the wavelength conversion device that uses the two-phase cooling system and in a wavelength conversion device according to a comparative example in which the two-phase cooling system is not used. It can be seen from FIG. 4 that the use of the two-phase cooling system makes it possible to stabilize the temperature of the phosphor relative to the light amount of the excitation light. Further, by reducing a pressure within the sealed housing that contains the phosphor layer and the refrigerant, the temperature of the phosphor is stabilized at a lower temperature. This is because a boiling point of the refrigerant is lowered by the reduced pressure in the sealed housing and a cooling performance is thereby improved.

Accordingly, the wavelength conversion device 10 according to the present embodiment makes it possible to obtain the fluorescence FL in which a light-emission wavelength is held. In addition, in the light source module 100 that uses the wavelength conversion device 10 according to the present embodiment, a light source output is stabilized. Accordingly, in a projector including the same (for example, the projector 1000; see FIG. 12) it is possible to suppress a luminance change and thereby to improve an image quality.

Further, in the present embodiment, the visible light reflection section 23 is provided on the face, of the outer circumferential face S4, that faces the circulation path 22, making it possible to return the fluorescence FL radiated on the circulation path 22 side of the phosphor layer 11 into the waveguide 21. Accordingly, it is possible to further improve the extraction efficiency of the fluorescence FL. In addition, for example, a portion of the excitation light EL that is applied to the phosphor layer 11 and propagates inside the phosphor layer 11 while being subjected to the multi-excitation may sometimes be transmitted from the inside of the phosphor layer 11 to the circulation path 22 side. Providing the visible light reflection section 23 on the face that faces the circulation path 22 makes it possible to cause the excitation light EL to enter the phosphor layer 11 again. Accordingly, it is possible to improve the use efficiency of the excitation light EL.

Furthermore, according to the present embodiment, the fluorescence reflection section 24 that causes the excitation light EL to transmit therethrough and selectively reflects the fluorescence FL is provided at the opening section 21H1 into which the excitation light EL enters. Thus, it is possible to further improve the extraction efficiency of the fluorescence FL. In addition, according to the present embodiment, the divergence angle control section 25 is provided at the opening section 21H2 from which the fluorescence FL and a portion of the excitation light EL are outputted. Thus, it is possible to control an output angle of the excitation light EL and the fluorescence FL to be outputted from the opening section 21H2. Hence, it is possible to improve a projection luminance of the projector provided with the same.

Further, according to the present embodiment, it is possible to achieve the non-rotating wavelength conversion device that has a high efficiency cooling performance and allows for a stable use. Thus, it is possible to achieve a miniaturization of the light source module and the projector. Further, a concern of an image quality degradation due to a rotational flicker is eliminated as compared with a case where a rotational wavelength conversion device is used. Thus, it is possible to further improve the stability of the light source output. In addition, it is possible to further improve the image quality of the projector provided with the same as well.

Next, modification examples 1 to 6, application examples, and applied examples will be described. Hereinafter, the similar components to those of the embodiment described above are denoted by the same reference numerals, and description thereof is omitted as appropriate.

### 2. MODIFICATION EXAMPLES

### 2-1. Modification Example 1

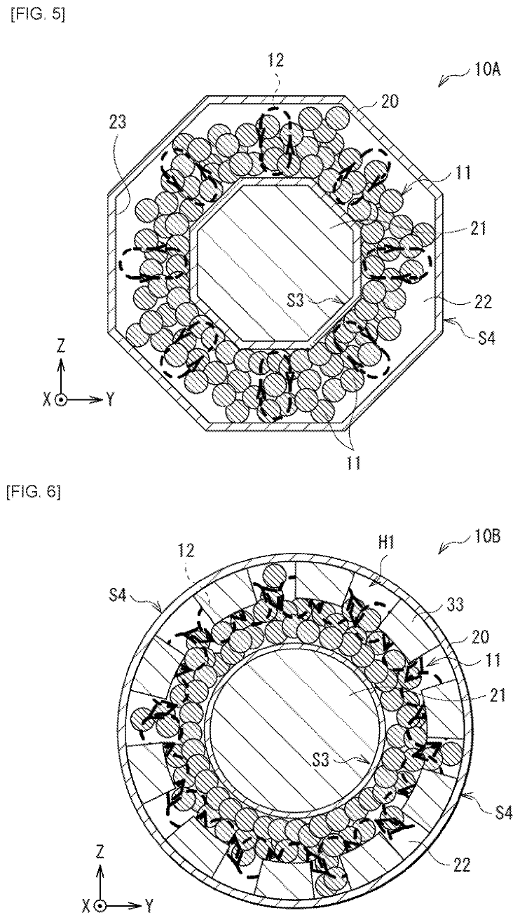

FIG. 5 schematically illustrates an example of a cross-sectional configuration of a wavelength conversion device (a wavelength conversion device 10A) according to modification example 1 of the present disclosure, and corresponds to, for example, a cross section in the X plane illustrated in FIG. 1. The wavelength conversion device 10A constitutes the light source module (the light source module 100) of the projection type display apparatus (e.g., the projector 1000) as with the embodiment described above. In the embodiment described above, an example is described in which the columnar structure member having a cylindrical shape in which a cross section is circular is used as the container section 20. However, it is not limited thereto. For example, as illustrated in FIG. 5, a columnar structure member having a polygonal cylindrical shape whose cross-section is a multangular shape may be used.

### 2-2. Modification Example 2

FIG. 6 schematically illustrates an example of a cross-sectional configuration of a wavelength conversion device (a wavelength conversion device 10B) according to modification example 2 of the present disclosure, and corresponds to, for example, a cross section in the X plane illustrated in FIG. 1. The wavelength conversion device 10B constitutes the light source module (the light source module 100) of the projection type display apparatus (e.g., the projector 1000) as with the embodiment described above. The wavelength conversion device 10B according to the present modification example differs from that of the embodiment described above, in that a visible light reflection section 33 that is in contact with the outer circumferential face S4 of the container section 20 and the phosphor layer 11 is provided at an outer part of the phosphor layer 11 in the circulation path 22.

The visible light reflection section 33 is for reflecting, toward the phosphor layer 11, the excitation light EL and the fluorescence FL outputted from the inside of the phosphor layer 11 to the circulation path 22 side as with the visible light reflection section 23 in the embodiment described above. The visible light reflection section 33 corresponds to one concrete example of a “second reflection section” of the present disclosure.

The visible light reflection section 33 is preferably formed using, for example, a continuous foam type porous member having a light-reflection property. This makes it possible to use the visible light reflection section 33 as a refrigerant transporting member. A pore (a void) in the visible light reflection section 33 preferably has an average pore diameter greater than an average pore diameter of the phosphor layer 11. Thus, the capillary force generated in the phosphor layer 11 becomes larger than a capillary force generated in the visible light reflection section 33, which makes the refrigerant 12 efficiently transported from the visible light reflection section 33 to the phosphor layer 11.

Preferably, the visible light reflection section 33 further has a plurality of openings H1. The plurality of openings H1 may have, for example, a line-shape that extends in one direction (e.g., X-axis direction) to divide the visible light reflection section 33 into a plurality of visible light reflection sections, or may be through-holes that partially penetrate the visible light reflection section 33. Providing the openings H1 promotes the circulation of the refrigerant 12. Specifically, the refrigerant 12 vaporized in the phosphor layer 11 moves to the openings H1 of the visible light reflection section 33, and the vaporized refrigerant 12 having moved to the openings H1 releases the latent heat through the outer circumferential face S4 of the container section 20 and re-liquefies. The liquefied refrigerant 12 is transported to the phosphor layer 11 by the capillary force of the visible light reflection section 33 and moves to the heat-generation part of the phosphor layer 11 by the capillary force of the phosphor layer 11.

It is possible to form the visible light reflection section 33 using, for example, barium sulfate as a separate body from the outer circumferential face S4 of the container section 20. Besides, the visible light reflection section 33 may be formed, for example, by directly forming a dielectric multilayered film on the phosphor layer 11. Alternatively, the visible light reflection section 33 may be formed on a base member (not illustrated), which may be so disposed in the circulation path 22 that the visible light reflection section 33 comes into contact with the phosphor layer 11.

As described above, according to the present modification example, the visible light reflection section 33 that has the continuous foam type porous structure and is in contact with the outer circumferential face S4 of the container section 20 and the phosphor layer 11 is provided in the circulation path 22. Thus, as compared with a case where a portion of the phosphor layer 11 is brought into contact with the outer circumferential face S4 of the container section 20 as with the embodiment described above, it is possible to promote the penetration of the liquid-like refrigerant 12 into the phosphor layer 11 and the movement of the vaporized refrigerant 12 to the outer circumferential face S4. Accordingly, it is possible to further improve the cooling efficiency, besides the effects of the embodiment described above.

### 2-3. Modification Example 3

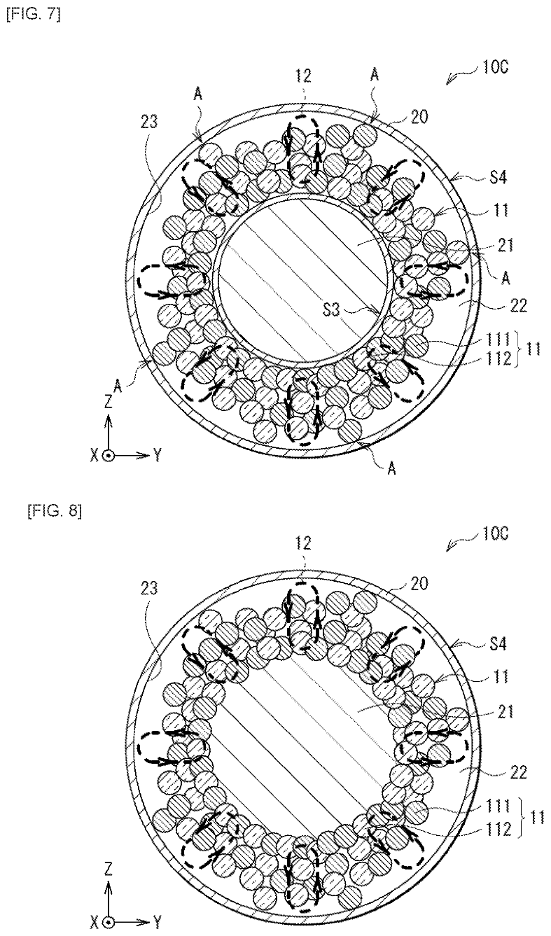

FIG. 7 schematically illustrates an example of a cross-sectional configuration of a wavelength conversion device (a wavelength conversion device 10C) according to modification example 3 of the present disclosure, and corresponds to, for example, a cross section in the X plane illustrated in FIG. 1. The wavelength conversion device 10C constitutes the light source module (the light source module 100) of the projection type display apparatus (e.g., the projector 1000) as with the embodiment described above. The wavelength conversion device 10C according to the present modification example differs from that of the embodiment described above, in that the phosphor layer 11 is formed by mixing the plurality of phosphor particles 111 and a plurality of transparent particles 112.

It is possible to form the transparent particles 112 using, for example, silicon oxide (SiO₂), titanium oxide (TiO₂), and aluminum oxide (Al₂O₃). It is preferable that the plurality of phosphor particles 111 and the plurality of transparent particles 112 be so mixed that, for example, a concentration of the phosphor particles 111 in the phosphor layer 11 is 60% by volume or less. Thereby, it is possible to . . . . An average particle size of the transparent particle 112 is, for example, 5 nm or greater and 30 μm or less as with the phosphor particle 111.

As described above, according to the present modification example, the plurality of phosphor particles 111 and the plurality of transparent particles 112 are mixed to provide the phosphor layer 11. Thus, it is possible to optimize the concentration of the phosphor particles in the phosphor layer 11. Accordingly, it is possible to achieve an effect in which the absorption amount of the excitation light EL in a predetermined region is alleviated, besides the effects of the embodiment described above.

Further, according to the present modification example, by closely coupling the phosphor particles 111 and the transparent particles 112 on the waveguide 21 side of the phosphor layer 11, it is possible to replace the inner circumferential face S3 of the container section 20 with the phosphor layer 11 as illustrated in FIG. 8. Thus, the excitation light EL is directly applied to the plurality of phosphor particles 111 constituting the phosphor layer 11 and propagates in the phosphor layer 11 while being scattered, whereby the excitation efficiency of the phosphor rises. It should be noted that, in a case where there is the inner circumferential face S3, the excitation light EL is specularly reflected at an interface of the inner circumferential face S3 and almost no scattering occurs.

### 2-4. Modification Example 4

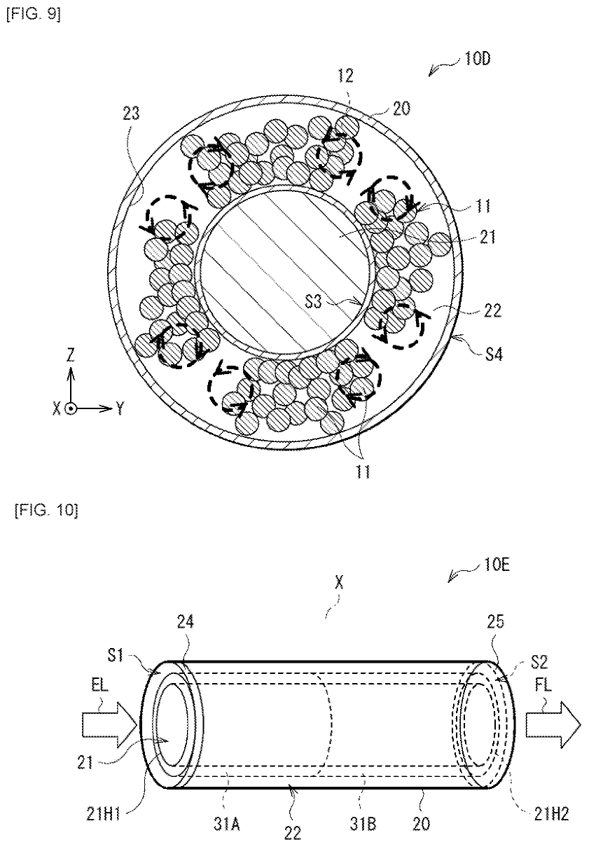

FIG. 9 schematically illustrates an example of a cross-sectional configuration of a wavelength conversion device (a wavelength conversion device 10D) according to modification example 4 of the present disclosure, and corresponds to, for example, a cross section in the X plane illustrated in FIG. 1. The wavelength conversion device 10D constitutes the light source module (the light source module 100) of the projection type display apparatus (e.g., the projector 1000) as with the embodiment described above. The wavelength conversion device 10D according to the present modification example differs from that of the embodiment described above, in that the phosphor layer 11 has a plurality of openings H2 and the phosphor layer 11 is intermittently formed along the inner circumferential face S3.

As described above, by providing the openings H2 on the phosphor layer 11, the refrigerant 12 vaporized at the heat-generation part of the phosphor layer 11 becomes easily moved to an outer part of the phosphor layer 11, and a circulation efficiency of the refrigerant 12 is improved. Accordingly, it is possible to further improve the cooling efficiency of the phosphor layer 11, besides the effects of the embodiment described above.

### 2-5. Modification Example 5

FIG. 10 schematically illustrates an example of a schematic configuration of a wavelength conversion device (a wavelength conversion device 10E) according to modification example 5 of the present disclosure. The wavelength conversion device 10E constitutes the light source module (the light source module 100) of the projection type display apparatus (e.g., the projector 1000) as with the embodiment described above. In the embodiment described above, an example is described in which the phosphor layer 11 is formed to include one type of phosphor particles 111; however, the phosphor layer 11 may be formed using a plurality of kinds of phosphor particles different from each other in light-emission wavelength. In the present modification example, for example, described is an example of a case in which two kinds of phosphor particles are used to form the phosphor layer 31.

In the phosphor layer 31, for example, a phosphor layer 31A and a phosphor layer 31B each including phosphor particles having different light-emission wavelengths from each other are disposed side by side in a propagation direction (e.g., the X-axis direction) of the excitation light EL. The phosphor is excited only by light of a wavelength shorter than its own light-emission wavelength. Accordingly, for example, in a case where the phosphor layer 31A includes the phosphor particles that emit a fluorescence of, for example, a yellow wavelength band and the phosphor layer 31B includes the phosphor particles that emit a fluorescence of, for example, a red wavelength band, it is preferable that the phosphor layer 31A be disposed on the opening section 21H1 side of the waveguide 21 and the phosphor layer 31B be disposed on the opening section 21H2 side of the waveguide 21, as illustrated in FIG. 10. In addition, the phosphor layer 31 may be formed by mixing two kinds of phosphor particles, for example.

As described above, according to the present modification example, the phosphor layer 31 is formed using the plurality of kinds of phosphor particles that are different from each other in light-emission wavelength. Thus, it is possible to design any emission spectrum of the light to be outputted from the waveguide 21. Hence, it is possible to provide a projection type display apparatus capable of projecting a wide color gamut picture, besides the effects of the embodiment described above.

### 2-6. Modification Example 6

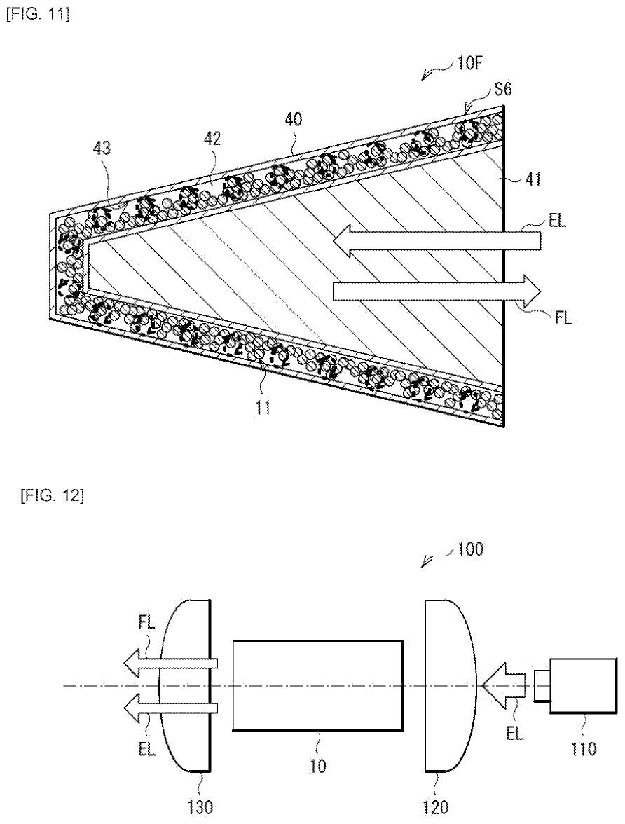

FIG. 11 schematically illustrates an example of a schematic configuration of a wavelength conversion device (a wavelength conversion device 10F) according to modification example 6 of the present disclosure. The wavelength conversion device 10F constitutes the light source module (the light source module 100) of the projection type display apparatus (e.g., the projector 1000) as with the embodiment described above. The wavelength conversion device 10F according to the present modification example differs from that of the embodiment described above, in that the entrance opening section into which the excitation light EL enters and the output opening section from which the fluorescence FL is outputted are the same.

The wavelength conversion device 10F is a so-called reflection type wavelength conversion device. In the wavelength conversion device 10F, for example, a columnar structure member having a trapezoidal cross-section is used as a container section 40 as illustrated in FIG. 11. The columnar structure member has an opening section 40H on a long side of two opposing parallel sides, and a short side and side faces have a double structure in which the inside is a sealed space. The present modification example has a hollow structure section on an inner side of an inner face S5 that constitutes the double structure, and the hollow structure section is used as a waveguide 41. In addition, the sealed space of the inside configured by the inner face S5 and an outer face S6 that constitute the double structure is used as a circulation path 42 in the sealed space of the inside. That is, the wavelength conversion device 10F according to the present modification example has the tapered waveguide 41, and each of the excitation light EL and the fluorescence FL enters one opening section 41H or is outputted from one opening section 41H.

In the wavelength conversion device 10F, the phosphor layer 11 is provided along the inner face S5 that constitutes the waveguide 41, and a portion thereof is in contact with a face, of the outer face S6, that faces the circulation path 42. A visible light reflection section 43, for example, is provided on a face, of the outer face S6, that faces the circulation path 42 as with the embodiment described above.

As described above, in the wavelength conversion device 10F according to the present modification example, the excitation light EL that has entered from the opening section 40H propagates, for example, in an arrow direction in the waveguide 41 while multi-exciting the phosphor layer 11. The fluorescence FL propagates, for example, in an arrow direction and is outputted from the opening section 40H. In the present modification example, the waveguide 41 has a tapered shape in which the opening section 41H is wide in width. Accordingly, the present modification example has a structure that allows the fluorescence FL and a portion of the excitation light EL not absorbed by the phosphor layer 11 to be easily taken out.

### 3. APPLICATION EXAMPLES

(Configuration Example of Light Source Module)

FIG. 12 is an outline diagram illustrating an example of an entire configuration of the light source module 100 used in, for example, the projector 1000 described later. The light source module 100 includes, for example, the wavelength conversion device 10 (any of the wavelength conversion devices 10 and 10A to 10E described above), the light source section 110, a light condensing optical system 120, and a collimating optical system 130. Each member constituting the light source module 100 is disposed in the order of the light condensing optical system 120, the wavelength conversion device 10, and the collimating optical system 130 on an optical path of light (the excitation light EL) to be outputted from the light source section 110.

The light source section 110 has a solid-state light-emitting device that emits light of a predetermined wavelength. As the solid-state light-emitting device, for example, a semiconductor laser device that oscillates blue laser light having a wavelength of 445 nm or a wavelength of 455 nm is used as the excitation light EL.

It should be noted that, in a case where the light source section 110 is configured by the semiconductor laser device, a configuration may be employed in which the excitation light EL of a predetermined output is obtained by one semiconductor laser device, or a configuration may be employed in which the excitation light EL of the predetermined output is obtained by multiplexing pieces of output light from a plurality of semiconductor laser devices. Further, the wavelength of the excitation light EL is not limited to the numerical value described above. It is possible to use any wavelength as long as the wavelength is within a wavelength band of light referred to as the blue light. In addition, a light emitting diode (LED) may be used as the solid-state light-emitting device.

The light condensing optical system 120 condenses the excitation light EL outputted from the light source section 110 to a predetermined spot diameter, and outputs the condensed excitation light EL to the wavelength conversion device 10. The light condensing optical system 120 may be configured by, for example, one lens or a plurality of lenses.

The collimating optical system 130 converts the fluorescence FL and a portion of the excitation light EL outputted from the wavelength conversion device 10 into parallel light, and outputs the parallel light to an illumination optical system 200 described later. The collimating optical system 130 may be configured by one collimator lens or a plurality of lenses.

(Configuration Example 1 of Projector)

FIG. 13 is an outline diagram illustrating an entire configuration of the projector 1000 that includes the light source module 100 illustrated in FIG. 12 as a light source optical system. It should be noted that, in the following, described as an example is a projector of a reflective 3 LCD type in which a light modulation is performed by a reflective liquid crystal panel (LCD).

Referring to FIG. 13, the projector 1000 includes the light source module 100 described above, the illumination optical system 200, an image formation section 300, and a projection optical system 400 in order.

The illumination optical system 200 has, for example, fly-eye lenses 210 (210A and 210B), a polarization conversion device 220, a lens 230, dichroic mirrors 240A and 240B, reflection mirrors 250A and 250B, lenses 260A and 260B, a dichroic mirror 270, and polarization plates 280A to 280C, from a position close to the light source module 100.

The fly-eye lenses 210 (210A and 210B) are intended to homogenize an illuminance distribution of white light that has entered from the light source module 100. The polarization conversion device 220 functions to align a polarization axis of incident light in a predetermined direction, and converts, for example, light other than P-polarized light into the P-polarized light. The lens 230 condenses light from the polarization conversion device 220 to the dichroic mirrors 240A and 240B. The dichroic mirrors 240A and 240B each selectively reflect light of a predetermined wavelength band and cause light of another wavelength band to transmit therethrough selectively. For example, the dichroic mirror 240A mainly reflects red light in a direction of the reflection mirror 250A. In addition, the dichroic mirror 240B mainly reflects blue light in a direction of the reflection mirror 250B. Accordingly, green light is mainly transmitted through both of the dichroic mirrors 240A and 240B, and is directed to a reflection polarization plate 310C (described later) of the image formation section 300. The reflection mirror 250A reflects light (mainly red light) from the dichroic mirror 240A to the lens 260A, and the reflection mirror 250B reflects light (mainly blue light) from the dichroic mirror 240B to the lens 260B. The lens 260A causes light (mainly red light) from the reflection mirror 250A to transmit therethrough and condenses the light to the dichroic mirror 270. The lens 260B causes light (mainly blue light) from the reflection mirror 250B to transmit therethrough and condenses the light to the dichroic mirror 270. The dichroic mirror 270 selectively reflects green light and causes light of another wavelength band to transmit therethrough selectively. Here, a red light component of the light from the lens 260A is transmitted. In a case where light from the lens 260A contains a green light component, the green light component is reflected to the polarization plate 280C. The polarization plates 280A to 280C include a polarizer having a polarization axis in a predetermined direction. For example, in a case where the conversion is performed to the P-polarized light in the polarization conversion device 220, the polarization plates 280A to 280C cause the P-polarized light to transmit therethrough and reflect S-polarized light.

The image formation section 300 has reflection polarization plates 310A to 310C, reflection type liquid crystal panels 320A to 320C (light modulation devices), and a dichroic prism 330.

The reflection polarization plates 310A to 310C cause light (e.g., the P-polarized light) having the same polarization axis as the polarized light from the polarization plate 280A to 280C to transmit therethrough and reflect light of the other polarization axis (the S-polarized light), respectively. Specifically, the reflection polarization plate 310A causes red light of the P-polarized light from the polarization plate 280A to transmit therethrough in a direction of the reflection type liquid crystal panel 320A. The reflection polarization plate 310B causes blue light of the P-polarized light from the polarization plate 280B to transmit therethrough in a direction of the reflection type liquid crystal panel 320B. The reflection polarization plate 310C causes green light of the P-polarized light from the polarization plate 280C to transmit therethrough in a direction of the reflection type liquid crystal panel 320C. In addition, the green light of the P-polarized light having transmitted through both of the dichroic mirrors 240A and 240B and entered the reflection polarization plate 310C is transmitted through the reflection polarization plate 310C as it is and enters the dichroic prism 330. Further, the reflection polarization plate 310A reflects the red light of the S-polarized light from the reflection type liquid crystal panel 320A and causes the reflected red light to enter the dichroic prism 330. The reflection polarization plate 310B reflects the blue light of the S-polarized light from the reflection type liquid crystal panel 320B and causes the reflected blue light to enter the dichroic prism 330. The reflection polarization plate 310C reflects the green light of the S-polarized light from the reflection type liquid crystal panel 320C and causes the reflected green light to enter the dichroic prism 330.

The reflection type liquid crystal panels 320A to 320C each perform a spatial modulation of the red light, the blue light, or the green light.

The dichroic prism 330 synthesizes the red light, the blue light, and the green light that has entered the dichroic prism 330, and outputs the synthesized light to the projection optical system 400.

The projection optical system 400 has lenses L410 to L450 and a mirror M400. The projection optical system 400 enlarges the output light from the image formation section 300 and projects the enlarged output light to a screen 500 or the like.

(Operations of Light Source Module and Projector)

Next, an operation of the projector 1000 including the light source module 100 will be described with reference to FIGS. 12 and 13.

First, the excitation light EL is oscillated from the light source section 110 to the light condensing optical system 120. The excitation light EL is transmitted through the light condensing optical system 120 and enters the opening section 21H1 of the wavelength conversion device 10. In the wavelength conversion device 10, a portion of the excitation light EL (the blue light) is absorbed in the phosphor layer 11 and converted into light (the fluorescence FL; yellow light) of a predetermined wavelength band. The fluorescence FL emitted from the phosphor layer 11 propagates in the waveguide 21 together with a portion of the excitation light EL not absorbed by the phosphor layer 11. As a result, the fluorescence FL and a portion of the excitation light EL are combined in in the wavelength conversion device 10 to generate white light, and the white light (the fluorescence FL and the excitation light EL) are outputted from the output opening section (the opening section 21H2) to the collimating optical system 130. Thereafter, the white light is transmitted through the collimating optical system 130 and enters the illumination optical system 200.

The white light that has entered from the light source module 100 is sequentially transmitted through the fly-eye lenses 210 (210A and 210B), the polarization conversion device 220, and the lens 230, and then reaches the dichroic mirrors 240A and 240B.

The red light is mainly reflected by the dichroic mirror 240A, and the red light is sequentially transmitted through the reflection mirror 250A, the lens 260A, the dichroic mirror 270, the polarization plate 280A, and the reflection polarization plate 310A, and reaches the reflection type liquid crystal panel 320A. The red light is spatially modulated at the reflection type liquid crystal panel 320A and then reflected at the reflection polarization plate 310A and enters the dichroic prism 330. It should be noted that, in a case where the light reflected to the reflection mirror 250A by the dichroic mirror 240A includes a green light component, the green light component is reflected by the dichroic mirror 270 and sequentially transmitted through the polarization plate 280C and the reflection polarization plate 310C to reach the reflection type liquid crystal panel 320C. In the dichroic mirror 240B, the blue light is mainly reflected and enters the dichroic prism 330 through a similar process. The green light transmitted through the dichroic mirrors 240A and 240B also enters the dichroic prism 330.

The red light, the blue light, and the green light that have entered the dichroic prism 330 are synthesized and the synthesized light is outputted as picture light to the projection optical system 400. The projection optical system 400 enlarges the picture light entered from the image formation section 300 and projects the enlarged picture light onto the screen 500 or the like.

(Configuration Example 2 of Projector)

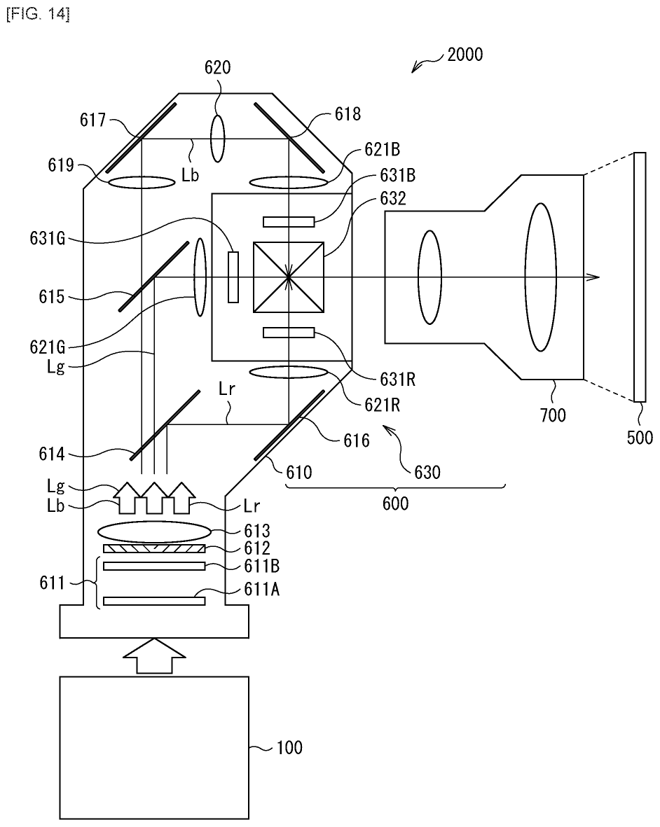

FIG. 14 is an outline diagram illustrating an example of a configuration of a projection type display apparatus (a projector 2000) of a transmission 3 LCD type in which a light modulation is performed by a transmission type liquid crystal panel. The projector 1000 includes, for example, the light source module 100, an image generation system 600 having an illumination optical system 610 and an image generation section 630, and a projection optical system 700.

The illumination optical system 610 includes, for example, an integrator device 611, a polarization conversion device 612, and a condenser lens 613. The integrator device 611 includes a first fly-eye lens 611A having a plurality of micro-lenses arranged in two dimensions and a second fly-eye lens 611B having a plurality of micro-lenses arranged to correspond one by one to each of the micro-lenses.

Light (parallel light) entering the integrator device 611 from the light source module 100 is divided into a plurality of light beams by the micro-lenses of the first fly-eye lens 611A, and the light beams are respectively imaged on the corresponding micro-lenses in the second fly-eye lens 611B. The micro-lenses of the second fly-eye lens 611B each function as a secondary light source, and apply a plurality of pieces of parallel light having a uniform luminance to the polarization conversion device 612 as incident light.

The integrator device 611 as a whole has a function of arranging the incident light, applied from the light source module 100 to the polarization conversion device 612, into a uniform luminance distribution.

The polarization conversion device 612 has a function of aligning a polarization state of the incident light entering through the integrator device 611 or the like. The polarization conversion device 612 outputs output light that includes blue light Lb, green light Lg, and red light Lr through, for example, a lens or the like disposed on an output side of the light source module 100.

The illumination optical system 610 further includes a dichroic mirror 614 and a dichroic mirror 615, a mirror 616, a mirror 617 and a mirror 618, a relay lens 619 and a relay lens 620, a field lens 621R, a field lens 621G, and a field lens 621B, liquid crystal panels 631R, 631G, and 631B as an image generation section 630, and a dichroic prism 632.

The dichroic mirror 614 and the dichroic mirror 615 have a property of selectively reflecting color light of a predetermined wavelength band and causing light of another wavelength band to transmit therethrough. For example, the dichroic mirror 614 selectively reflects the red light Lr. The dichroic mirror 615 selectively reflects the green light Lg, out of the green light Lg and the blue light Lb having transmitted through the dichroic mirror 614. The remaining blue light Lb is transmitted through the dichroic mirror 615. Thus, the light outputted from the light source module 100 (for example, white combined light Lw) is separated into a plurality of pieces of color light of different colors.

The separated red light Lr is reflected by the mirror 616, and the reflected red light is collimated by passing through the field lens 621R, and the collimated red light enters the liquid crystal panel 631R used for a modulation of the red light. The green light Lg is collimated by passing through the field lens 621G, and the collimated green light enters the liquid crystal panel 631G used for a modulation of the green light. The blue light Lb passes through the relay lens 619 and is reflected by the mirror 617, and further passes through the relay lens 620 and reflected by the mirror 618. The blue light Lb reflected by the mirror 618 is collimated by passing through the field lens 621B, and the collimated blue light enters the liquid crystal panel 631B used for a modulation of the blue light Lb.

The liquid crystal panels 631R, 631G, and 631B are electrically coupled to an unillustrated signal source (e.g., a personal computer or the like) that supplies an image signal containing image information. The liquid crystal panels 631R, 631G, and 631B modulate the incident light for each pixel on the basis of the supplied image signal of each color to generate a red image, a green image, and a blue image, respectively. The modulated pieces of light of the respective colors (formed images) enter the dichroic prism 632 to be synthesized. The dichroic prism 632 superimposes the pieces of light of the respective colors that has entered from three directions and synthesizes the pieces of light, and outputs the synthesized light to the projection optical system 700.

The projection optical system 700 has, for example, a plurality of lenses and the like. The projection optical system 700 enlarges the output light from the image generation system 600 and projects the enlarged output light onto the screen 500.

### 4. APPLIED EXAMPLES

### Applied Example 1

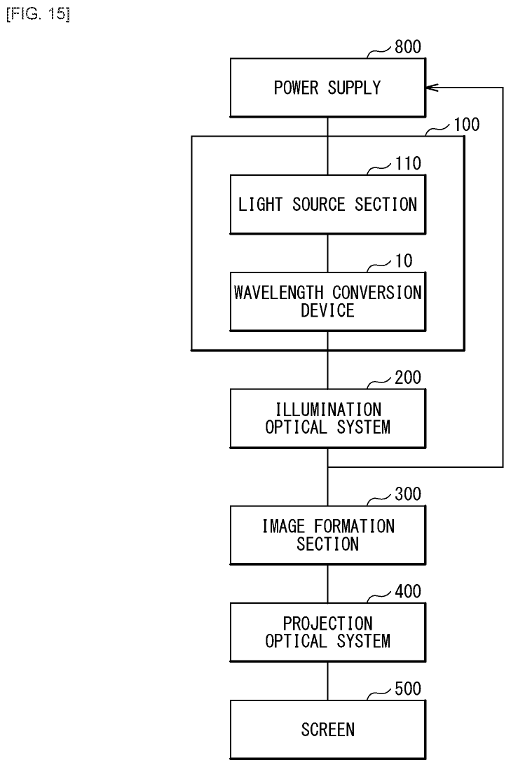

FIG. 15 illustrates an example of a flow of a light-emission wavelength variation feedback function to be applied to the projector 1000, for example. In the embodiment described above, it has been described that the temperature of the phosphor layer 11 is constant with respect to the excitation light amount, and that it is possible to stabilize the fluorescent light emission wavelength. However, it can be seen from a characteristic diagram illustrated in FIG. 4 that the temperature of the phosphor layer 11 is not stable in a low excitation light amount region even in a case where the two-phase cooling system is applied. The temperature of the phosphor layer 11 rises substantially linearly with respect to the excitation light amount. Accordingly, for example, by adding inside the projector 1000 a function of feeding back the variation of a light-emission wavelength caused by a temperature change of the phosphor layer 11 (a light-emission wavelength variation feedback function), it becomes possible to adjust a color balance of a picture to be projected onto the screen.

In the light-emission wavelength variation feedback function according to the present applied example, for example, light that enters the image formation section 300 from the illumination optical system 200 is received and acquired by a sensor to obtain information on the light-emission wavelength. The information on the light-emission wavelength is fed back to a power supply 800 coupled to the light source section 110. In the light source section 110, a value of a current to be injected into the light source section 110 is adjusted on the basis of the fed-back information to adjust a light amount of the excitation light EL to be outputted from the light source section 110. Accordingly, it becomes possible to stabilize the light-emission wavelength of the fluorescence FL to be outputted from the wavelength conversion device 10 even in the low excitation light amount region.

### Applied Example 2

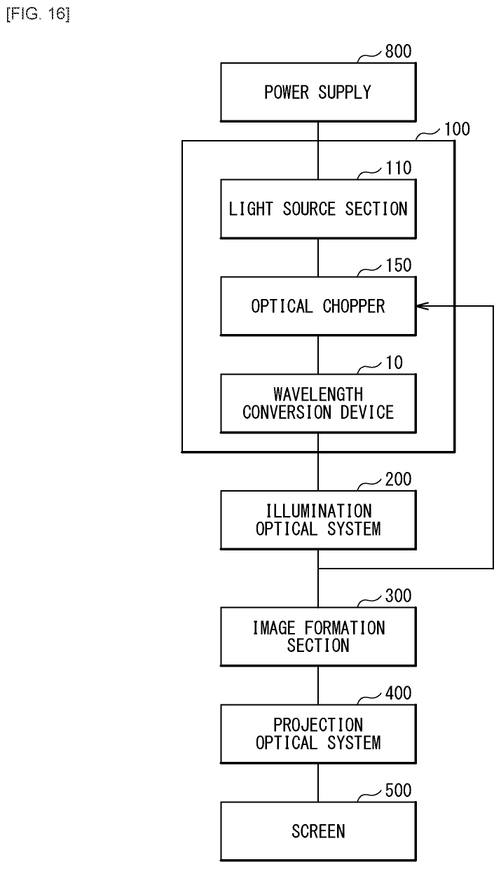

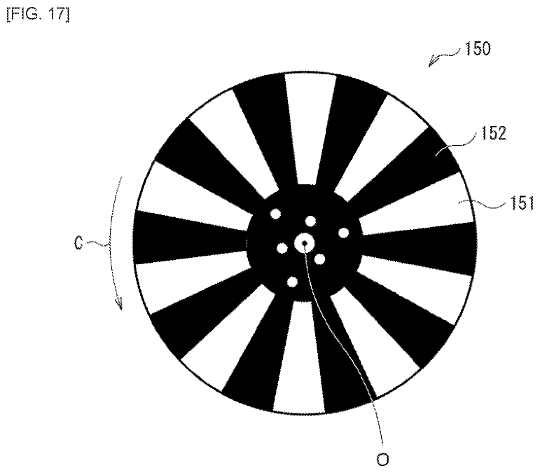

FIG. 16 illustrates another example of the flow of the light-emission wavelength variation feedback function to be applied to the projector 1000, for example. The light-emission wavelength variation feedback function according to the present applied example differs from the light-emission wavelength variation feedback function described above, in that an optical chopper 150 is disposed between the light source section 110 and the wavelength conversion device 10.

FIG. 17 schematically illustrates an example of a configuration of the optical chopper 150. The optical chopper 150 is, for example, an optical element that has a disk shape and is rotatable about the center O in, for example, an arrow C direction. The optical chopper 150 includes, for example, a plurality of transmission sections 151 and a plurality of non-transmission sections 152 disposed radially and alternately.

In the present applied example, the optical chopper 150 is disposed between the light source section 110 and the wavelength conversion device 10, and light that enters the image formation section 300 from the illumination optical system 200 is received and acquired by a sensor to obtain information on the light-emission wavelength, and the information is fed back to a rotational speed of the optical chopper 150. Accordingly, it becomes possible to adjust the light amount of the excitation light EL that enters the wavelength conversion device 10, and to stabilize the light-emission wavelength of the fluorescence FL to be outputted from the wavelength conversion device 10 even in the low excitation light amount region.

Although the present disclosure has been described with reference to the embodiment, the modification examples 1 to 6, the application examples, and the applied examples, the present disclosure is not limited to the above-described embodiment and the like, and various modifications can be made. For example, materials and the like of respective members referred to in the above embodiment are exemplary and are not limited thereto.

Further, although the above modification examples 1 to 6 have been described as modification examples of the embodiment, a configuration may be employed in which the modification examples are combined with each other.

Furthermore, it is possible for the wavelength conversion device of the present technology (e.g., the wavelength conversion device 10) to be used also for a light source module having a configuration other than the light source module 100 described above and a projector having a configuration other than the projectors 1000 and 2000 described above. For example, in the above projectors 1000 and 2000, an example in which the reflection type liquid crystal panel or the transmission type liquid crystal panel is used as the light modulation device is illustrated, but the present technology may be applied to a projector in which a digital micro-mirror device (DMD: Digital Micro-mirror Device) or the like is used.

Further, in the present technology, the wavelength conversion device 10 and the light source module 100 according to the present technology may be used in an electronic apparatus that is not the projection type display apparatus. For example, the light source module 100 described above may be used as an illumination application. For example, the light source module 100 described above may be applied to a light source for a headlight of an automobile and a light source for light-up.

It should be noted that the effects described in the above embodiment and the like are not necessarily limited, and may be any of the effects described in the present disclosure.

It should be noted that the present technology may have the following configurations. According to the present technology of the following configurations, the circulation path in which the refrigerant circulates and the waveguide through which the excitation light and the fluorescence propagate are formed separately. Thus, the fluorescence and the excitation light are not scattered by the refrigerant. Hence, it is possible to improve the light extraction efficiency.

(1)

A wavelength conversion device including:

a phosphor layer including a plurality of phosphor particles;

a refrigerant that cools the phosphor layer;

a circulation path that contains the phosphor layer and the refrigerant, and in which the refrigerant circulates; and

a waveguide separated from the circulation path, and through which excitation light that excites the phosphor layer and a fluorescence excited by the excitation light and outputted from the phosphor layer propagate.

(2)

The wavelength conversion device according to (1), in which the circulation path is formed in an inner space configured by an opposing pair of end faces of a columnar structure member having a double structure and by an inner circumferential face and an outer circumferential face that form side faces of the columnar structure member.

(3)

The wavelength conversion device according to (2), in which the columnar structure member has a hollow structure section on an inner side of the inner circumferential face, and the hollow structure section serves as the waveguide.

(4)

The wavelength conversion device according to (2) or (3), in which the phosphor layer and the refrigerant are hermetically sealed in the inner space.

(5)

The wavelength conversion device according to any one of (1) to (4), in which the waveguide is filled by a transparent material having a refractive index of 1 or greater.

(6)

The wavelength conversion device according to any one of (2) to (5), in which a cross-sectional shape of the waveguide in a direction orthogonal to an extending direction of the columnar structure member is a circular shape or a multangular shape.

(7)

The wavelength conversion device according to any one of (2) to (6), in which the inner circumferential face of the columnar structure member has a light-transmitting property.

(8)

The wavelength conversion device according to any one of (1) to (7), in which the waveguide has an entrance opening section into which the excitation light enters and an output opening section from which the fluorescence is outputted.

(9)

The wavelength conversion device according to (8), in which the waveguide further has, at the entrance opening section, a first reflection section that selectively reflects the fluorescence emitted from the phosphor layer.

(10)

The wavelength conversion device according to any one of (2) to (9), in which the phosphor layer is formed continuously along the inner circumferential face of the columnar structure member.

(11)

The wavelength conversion device according to any one of (2) to (9), in which the phosphor layer is formed intermittently along the inner circumferential face of the columnar structure member.

(12)

The wavelength conversion device according to any one of (2) to (11), in which at least a portion of the phosphor layer is in contact with the outer circumferential face of the columnar structure member.

(13)

The wavelength conversion device according to any one of (2) to (12), in which a second reflection section that reflects visible light is formed on the outer circumferential face side of the phosphor layer.

(14)

The wavelength conversion device according to (13), in which a face, of the outer circumferential face, that faces the inner space serves as the second reflection section.

(15)

The wavelength conversion device according to (13) or (14), in which the second reflection section is provided between the phosphor layer and the outer circumferential face of the columnar structure member in contact with each of the phosphor layer and the outer circumferential face of the columnar structure member.

(16)

The wavelength conversion device according to any one of (1) to (15), in which the refrigerant has a vaporization heat of 10 cal/g or greater.

(17)

The wavelength conversion device according to any one of (1) to (16), in which the phosphor layer absorbs the excitation light and emits the fluorescence of a wavelength that is smaller than a wavelength of the excitation light.

(18)

The wavelength conversion device according to any one of (1) to (17), in which the phosphor layer emits the fluorescence having a wavelength of 480 nm or greater and 680 nm or less, or the fluorescence having a wavelength of 600 nm or greater and 680 nm or less.

(19)

The wavelength conversion device according to any one of (1) to (18), in which the phosphor layer absorbs 50% or greater of the excitation light.

(20)

The wavelength conversion device according to any one of (1) to (19), in which a concentration of the phosphor particles in the phosphor layer is equal to or less than 60% by volume.

(21)

The wavelength conversion device according to any one of (1) to (20), in which the plurality of phosphor particles has an average particle size of 5 nm or greater and 30 μm or less.

(22)

The wavelength conversion device according to any one of (1) to (21), in which the plurality of phosphor particles is encapsulated by or coated with an inorganic material.

(23)

The wavelength conversion device according to any one of (1) to (22), in which the phosphor layer is mixed with a transparent particle.

(24)

The wavelength conversion device according to any one of (1) to (23), in which the phosphor layer includes the plurality of kinds of phosphor particles that emits pieces of light of different wavelengths.

(25)

The wavelength conversion device according to any one of (1) to (24), in which the phosphor layer is directly cooled by a latent heat caused by a vaporization of the refrigerant.

The present application claims the benefit of Japanese Priority Patent Application JP2019-182226 filed with the Japan Patent Office on Oct. 2, 2019, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A wavelength conversion device comprising:
a phosphor layer including a plurality of phosphor particles;
a refrigerant that cools the phosphor layer;
a circulation path that contains the phosphor layer and the refrigerant, and in which the refrigerant circulates; and
a waveguide separated from the circulation path, and through which excitation light that excites the phosphor layer and a fluorescence excited by the excitation light and outputted from the phosphor layer propagate.

2. The wavelength conversion device according to claim 1, wherein the circulation path is formed in an inner space configured by an opposing pair of end faces of a columnar structure member having a double structure and by an inner circumferential face and an outer circumferential face that form side faces of the columnar structure member.

3. The wavelength conversion device according to claim 2, wherein the columnar structure member has a hollow structure section on an inner side of the inner circumferential face, and the hollow structure section serves as the waveguide.

4. The wavelength conversion device according to claim 2, wherein the phosphor layer and the refrigerant are hermetically sealed in the inner space.

5. The wavelength conversion device according to claim 1, wherein the waveguide is filled by a transparent material having a refractive index of 1 or greater.

6. The wavelength conversion device according to claim 2, wherein a cross-sectional shape of the waveguide in a direction orthogonal to an extending direction of the columnar structure member is a circular shape or a multangular shape.

7. The wavelength conversion device according to claim 2, wherein the inner circumferential face of the columnar structure member has a light-transmitting property.

8. The wavelength conversion device according to claim 1, wherein the waveguide has an entrance opening section into which the excitation light enters and an output opening section from which the fluorescence is outputted.

9. The wavelength conversion device according to claim 8, wherein the waveguide further has, at the entrance opening section, a first reflection section that selectively reflects the fluorescence emitted from the phosphor layer.

10. The wavelength conversion device according to claim 2, wherein the phosphor layer is formed continuously along the inner circumferential face of the columnar structure member.

11. The wavelength conversion device according to claim 2, wherein the phosphor layer is formed intermittently along the inner circumferential face of the columnar structure member.

12. The wavelength conversion device according to claim 2, wherein at least a portion of the phosphor layer is in contact with the outer circumferential face of the columnar structure member.

13. The wavelength conversion device according to claim 2, wherein a second reflection section that reflects visible light is formed on the outer circumferential face side of the phosphor layer.

14. The wavelength conversion device according to claim 13, wherein a face, of the outer circumferential face, that faces the inner space serves as the second reflection section.

15. The wavelength conversion device according to claim 13, wherein the second reflection section is provided between the phosphor layer and the outer circumferential face of the columnar structure member in contact with each of the phosphor layer and the outer circumferential face of the columnar structure member.

16. The wavelength conversion device according to claim 1, wherein the refrigerant has a vaporization heat of 10 cal/g or greater.

17. The wavelength conversion device according to claim 1, wherein the phosphor layer absorbs the excitation light and emits the fluorescence of a wavelength that is smaller than a wavelength of the excitation light.

18. The wavelength conversion device according to claim 1, wherein the phosphor layer emits the fluorescence having a wavelength of 480 nm or greater and 680 nm or less, or the fluorescence having a wavelength of 600 nm or greater and 680 nm or less.

19. The wavelength conversion device according to claim 1, wherein the phosphor layer absorbs 50% or greater of the excitation light.

20. The wavelength conversion device according to claim 1, wherein a concentration of the phosphor particles in the phosphor layer is equal to or less than 60% by volume.
